(19) United States
(12) Patent Application Publication
(10) Pub. No.: US 2006/0207063 A1
(43) Pub. Date: Sep. 21, 2006

(54) Vibration dampening handle

(75) Inventors: Timothy Jaszkowiak, Boise, ID (US); Marvin Whiteman, Boise, ID (US)

Correspondence Address: STEVEN C. JOHNSON;DYKAS, SHAVER & NIPPER, LLP, PO BOX 877, BOISE, ID, 83701-0877, US

(73) Assignee: Multiquip. Inc., Carson, CA (US)

(21) Appl. No.: 11/332,029

(22) Filed: Jan. 13, 2006

Related U.S. Application Data
(60) Provisional application No. 60/658,047, filed on Mar. 1, 2005.

(51) Int. Cl. E05B 1/00

(52) U.S. Cl. 16/436

(57) ABSTRACT

A vibration-dampening, height-adjustable handle for a power tool. Embodiments include a handle assembly connected to a shaft or frame via a plurality resilient fittings. The resilient fittings are arranged to conduct roll, pitch, and yaw forces sufficient to control the power tool. In some embodiments, the handle assembly rotates about at least one resilient fittings, and the height of the handlebar portion of the handle assembly is controlled by adjusting the distance between the shaft and another resilient fitting.

### CROSS-REFERENCE TO RELATED APPLICATIONS

This application claims the priority date of the provisional application entitled VIBRATION DAMPENED, HEIGHT-ADJUSTABLE POWER TROWEL HANDLE, filed by Timothy Jaszkowiak and Marvin Whiteman on Mar. 1, 2005, with application Ser. No. 60/658,047, incorporated herein by this reference.

### FIELD OF THE INVENTION

The present invention relates to generally to handles for power tools, and more particularly to vibration dampening handles for power tools.

### BACKGROUND OF THE INVENTION

Power tools are often operated through a handle assembly that extends from the operator's hands at a standing height to the main body of the tool at the floor or ground level. Such tools include, but are not limited to, those for finishing wet cement, cutting cement, polishing wood floors, sanding wood floors, and other power tools. A concrete power trowel is an example of a tool for finishing wet cement. These tools often impart considerable vibration through the handle to the operator's hands and arms, potentially causing fatigue and stress injuries. Furthermore, many power tools have fixed handles that are not adjustable to the height of the operator. Prior attempts to dampen vibration typically degrade controllability: the flexibility provided by the vibration dampening mechanism reduces the ability of the operator to control the tool. Other attempts to combine vibration dampening and height adjustability often worked at cross purposes: the height adjustment mechanism degraded vibration dampening.

Accordingly, there is a need for a height-adjustable operator handle that also dampens vibration produced by the operation of the tool.

### SUMMARY OF THE INVENTION

Embodiments of the present invention provide considerable vibration dampening while retaining controllability and height adjustability.

Vibrations transmitted to the operator through the handle may be dampened by employing an array of three resilient fittings that connect a handle assembly to the frame of the power tool. In some embodiments, the handle assembly rotates about at least one fitting, while the height of the handle is controlled at a height control assembly that interconnects the handle assembly and the frame via another resilient fitting. In other embodiments, the handle is connected to the frame via an array of two fittings.

In some embodiments, the height control assembly may be implemented as a threaded rod and a fastener threaded onto the rod. The fastener controls the angle of the handle assembly relative to the frame member.

The spacing of the resilient fittings allow the operator to control the tool by applying torque to the frame of the tool, while still retaining good dampening characteristics. The height control assembly works in concert with the resilient fittings to adjust height without any degradation in vibration dampening. The end result is a tool that remains controllable with significant reductions in vibration transmitted to the hands of the operator, with consequent reductions in stress, fatigue and risk of injury.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a partial, perspective view of a power tool handle according to an embodiment of the invention.

FIG. 2 is a partial, bottom plan view of the embodiment shown in FIG. 1.

FIG. 3 is a perspective view of a power tool employing the embodiment shown in FIGS. 1 and 2.

FIG. 4 is a partial, bottom plan view of a power tool handle according to another embodiment of the invention.

FIG. 5 is a partial, perspective view of components of a power tool handle according to the embodiment shown in FIG. 4.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

As shown in the figures for purposes of illustration, the invention is embodied in a novel power tool handle that provides vibration dampening and height-adjustability, while retaining control and stability. Existing handles have not been able to provide a combination of these benefits at reasonable cost and complexity.

In the following description and in the figures, like elements are identified with like reference numerals.

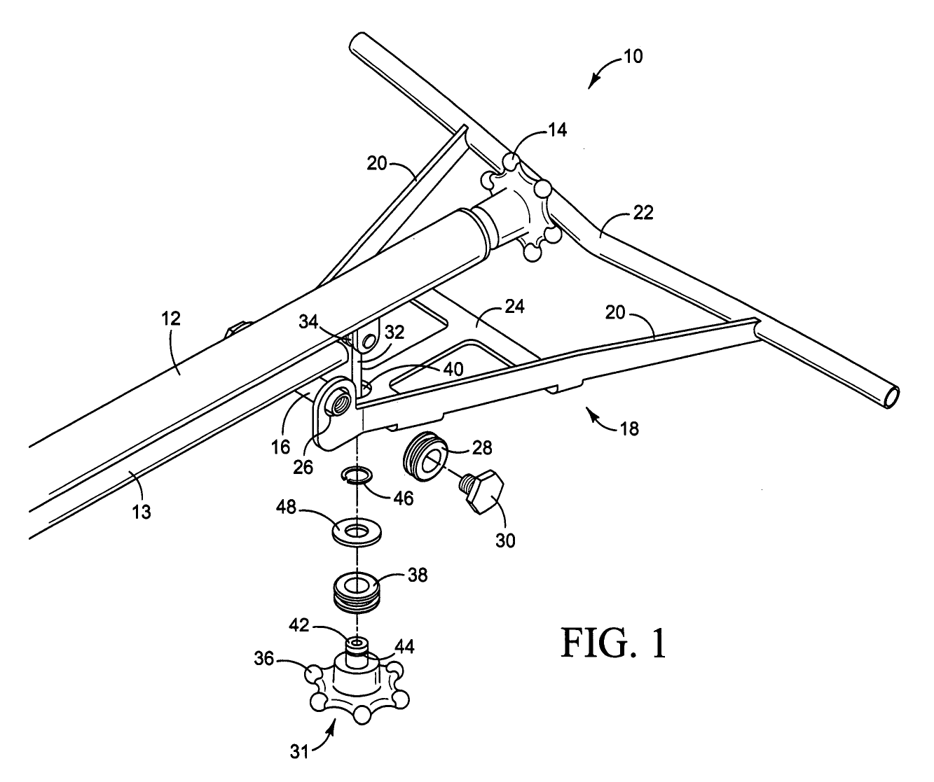

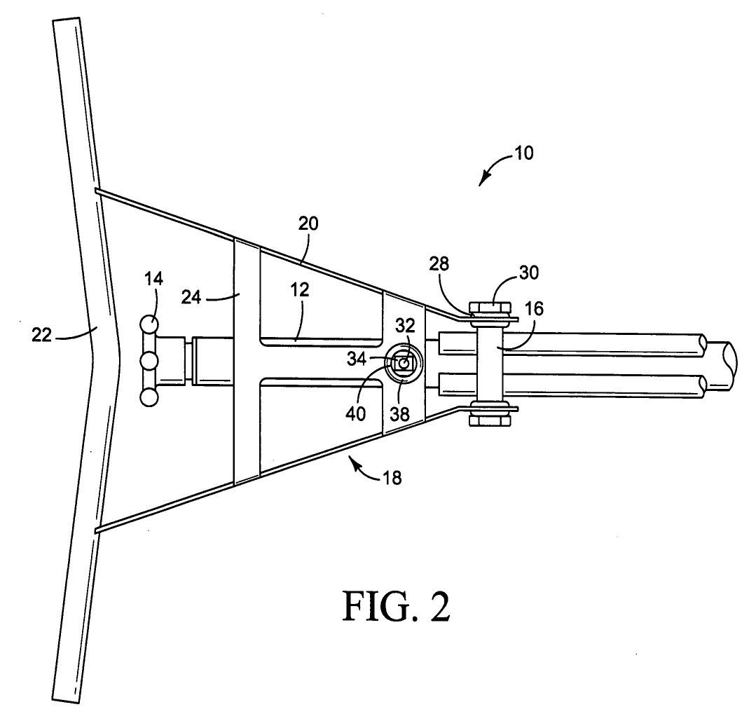

An embodiment of a vibration dampening handle 10 is shown in FIGS. 1 and 2. In the embodiment shown, the components are preferably symmetrical about the long axis of a rigid frame member 12. Generally, each handle component on one side of frame member 12 has a corresponding component on the side opposite the long axis of frame member 12. Frame member 12 may be joined to smaller tubing 13 for reinforcement.

Frame member 12 and associated tubing may also house electrical wiring, cables, and other control elements for controlling the power tool. For example, on a concrete power trowel, a hand wheel 14 may be used to rotate a control rod (not shown) passing through the center of frame member 12 to adjust the pitch angle of the trowel blades. A crossbar 16 is perpendicularly attached to the frame member 12.

The upper handle assembly 18 includes two legs 20, one end of each leg 20 attached to at least one handlebar 22. Handlebar 22 is preferably sized and oriented to present comfortable handgrips to the tool operator. Subframe 24 may be used to interconnect the legs 20 for additional strength. Upper handle assembly 18 is pivotably and flexibly attached to crossbar 16 at two contact regions, one on each end of crossbar 16.

In a preferred embodiment, handle assembly 18 may be flexibly attached to crossbar 16 using two resilient fittings, such as grommets. Still referring to FIG. 1, each leg 20 preferably defines a hole 26 near the end opposite handle 22. Each hole 26 has a diameter sufficiently large to receive the end of crossbar 16. A grommet 28 is inserted into each hole 26, and an end of crossbar 16 is inserted into a grommet 28, providing a flexible coupling between upper handle assembly 18 and frame member 12. In some embodiments, the grommets 28 may be retained by threading the interior of each end of crossbar 16 to receive a bolt 30. When installed, bolts 30 constrain lateral motion of upper handle assembly 18. In a preferred embodiment, grommets 28 each have an annular groove that captures the inner edge of each hole 26 so that grommets 28 remain in place as handle assembly 18 moves relative to crossbar 16.

The height of handlebar 22 above the ground may be controlled by a third contact region, allowing operators of different heights to comfortably use the power tool. Referring again to FIG. 1, the first two contact regions on crossbar 16 define an axis of rotation for handle assembly 18. Height control assembly 31 interconnects upper handle assembly 18 and frame member 12, defining a third contact region spaced away from the axis of rotation and controlling the angle between subframe 24 and frame member 12. In height control assembly 31, rod 32 is flexibly attached to frame member 12. In the embodiment shown in FIG. 1, rod 32 is attached to frame member 12 by a bearing 34, oriented to allow rod 32 to swing in a plane parallel to the longitudinal axis of frame member 12. The free end of rod 32 is threaded to accept knob 36. A grommet 38 is inserted into a hole 40 in subframe 24. Rod 32 passes through grommet 38 so that the threaded end protrudes below subframe 24. A knob 36 (FIG. 1) or other threaded fastener is screwed onto the end of rod 32 so that it supports subframe 24 through grommet 38, and controls the rotation of legs 20 about grommets 28. The angle that subframe 24 defines relative to frame member 12, and thus the height of handlebar 22, depends on the distance that knob 36 is screwed onto rod 32. Note that, for clarity, knob 36 and associated washers are not shown in FIG. 2.

In a preferred embodiment, grommet 38 has an annular groove that captures the inner edge of each hole 40 so that subframe 24 moves in concert with grommet 38. Other embodiments are possible: for example, two fiber or rubber washers encircling rod 32 and capturing the edge of hole 40 between them will suffice in some applications.

To be most effective, the third contact region, represented by grommet 38, must be spaced a distance away from the axis represented by the first two contact regions, represented by grommets 28. In other words, the contact regions should not be collinear. In the embodiment shown in FIGS. 1 and 2, grommet 38 is located roughly between the grommets 28 and handlebar 22. However, in alternative embodiments, crossbar 16 and grommets 28 may be located between grommet 38 and handlebar 22. It may also be appreciated that the height control assembly is subject to alternative implementations that control the distance between frame member 12 and subframe 24. For an exemplary embodiment, rod 32 may pass through frame member 12 and knob 36 screwed onto the protruding rod end, so that the height may be adjusted from above frame member 12. In another exemplary embodiment, a generally fixed handle height may be obtained by replacing knob 36 with a bolt and replacing rod 32 with a tube threaded to receive the bolt. The angle between subframe 24 and frame member 12, and thus the height of handlebar 22 above the ground, is set by the length of the tube.

In some embodiments, knob 36 has a hollow cylindrical protrusion 42 that passes through grommet 38. Protrusion 42 preferably has a circumvolving groove 44 to receive a retaining ring 46, which secures grommet 38 to knob 36. A washer 48 may be placed between retaining ring 46 and grommet 38 to protect grommet 38 from wear.

While frame member 12, crossbar 16, and handlebar 22 are preferably constructed of circular steel tubing, other materials and forms may be used. Similarly, while grommets 28 and second grommet 38 are preferably made of neoprene, other resilient materials may be used. While frame member 12 is shown as a single tube as an exemplary embodiment, other embodiments having different frame implementations are possible, including ladder frames, steel channel, or other frame configurations employing generally rigid elements.

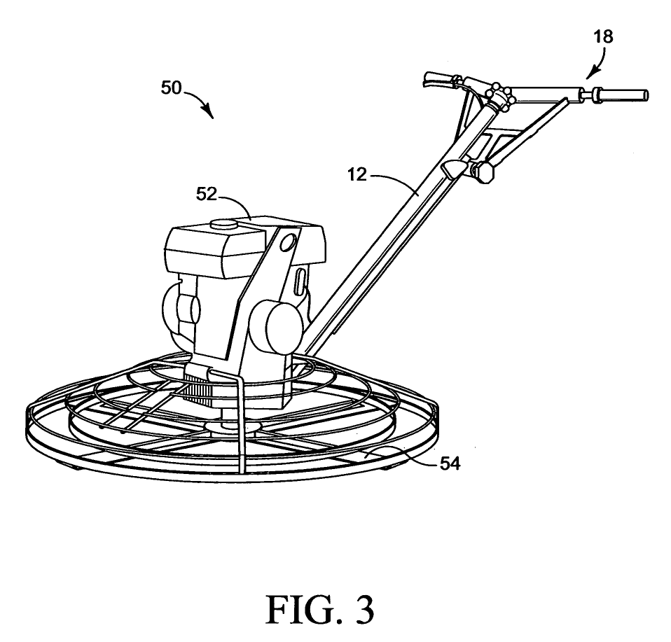

FIG. 3 illustrates handle assembly 18 installed on a power tool 50; specifically, a concrete power trowel. Upper handle assembly 18 is supported by frame member 12 solely through grommets 28 and 38 (FIG. 1). Vibrations produced by the engine 52 and moving parts, such as one or more blades 54, and conducted by frame member 12 are dampened by grommets 28 and 38, isolating upper handle assembly 18. Referring again to FIGS. 1 and 2, upper handle assembly 18 represents a mass that tends to remain motionless absent an applied force. This mass is effectively increased by the operator's hands and arms when grasping handlebar 22. The forces imparted by the vibration of frame member 12 are largely absorbed by grommets 28 and 38 before being applied to upper handle assembly 18. It may be appreciated that the higher the mass of upper handle assembly 18, the less motion is imparted to upper handle assembly 18 by the remaining small forces transmitted through grommets 28 and 38, and consequently less motion is transmitted to the operator's hands. Also, the amount of vibration transmitted by grommets 28 and 38 depend on their flexibility.

The three attachment points, grommets 28 and 38, are sufficiently spaced apart to allow the operator to apply torque to upper handle assembly 18 by rotating handle 22, adjusting roll; by displacing handle 22 up or down, adjusting pitch; or by displacing handle 22 laterally, adjusting yaw. The generally triangular layout of the contact regions shown in FIGS. 1 and 2 provides considerable vibration dampening while retaining the controllability required for proper operation of the power tool. For example, when handling a concrete power trowel, the operator often must adjust the angle of the plane described by the rotating blades relative to the concrete surface undergoing finishing. To rotate the tool clockwise, the operator must rotate frame member 12 clockwise. As the operator rotates handlebar 22, torque is applied by legs 20 to crossbar 16 through grommets 28. If the grommets 28 are spaced very close together, or if a single grommet were used, the upper handle assembly 18 would merely rotate relative to frame member 12 while applying very little torque to frame member 12. As the spacing between grommets 28 increases, the torque applied to frame member 12 increases for a given rotation of handlebar 22. From the operator's perspective, increasing the spacing between grommets 28 improves controllability. However, a smaller spacing may result in a more convenient size.

In a concrete power trowel application, it has been found that crossbar 16 should preferably be about six inches long so that the operator may apply sufficient rotational torque to frame member 12 to control the power trowel. In other applications, a smaller or greater length may be appropriate.

To adjust the pitch of the tool, the operator pushes handlebar 22 up and down, respectively. This motion is transmitted by legs 20 through grommets 28, and subframe 24 through grommet 38, to frame member 12. Again, increasing the distance between grommet 38 and crossbar 16 improves controllability. A similar analysis applies to motion in yaw, wherein the operator pushes the handle laterally.

To adjust the height of handlebar 22 to a comfortable position, the operator rotates knob 36, changing the effective length of rod 32 and the angle between legs 20 and frame member 12. To raise handlebar 22, the operator rotates knob 36 clockwise, when viewed from the bottom and using standard thread direction, screwing knob 36 farther onto rod 32 and shortening the effective length of rod 32. Grommet 38 is captured between washer 48 and the base of knob 36 so that grommet 38 moves along rod 32 with knob 36. The groove in grommet 38 or functionally similar feature captured in the inner edge of hole 40 in subframe 24, so that subframe 24 moves along with grommet 38 and knob 36. As the effective length of rod 32 is reduced, the angle between subframe 24 and frame member 12 is reduced, raising handlebar 22 relative to frame member 12, and raising handlebar 22 relative to the ground. To lower handlebar 22, the operator rotates knob 36 counterclockwise, effectively lengthening rod 32. Grommet 38 travels along rod 32 away from frame member 12, which increases the angle between subframe 24 and frame member 12, and lowers handlebar 22 relative to the ground.

To operate the power tool, the operator grasps handlebar 22, adjusts the height using knob 36 and then starts the power tool. During operation, handlebar 22 is kept relatively stationary by the operator's hands, and vibration transmitted through frame member 12 is dampened by the grommets 28 and 38, so that vibration is not conducted to upper handle assembly 18. Larger motions imparted to upper handle assembly 18 by the operator's hands are conducted through the grommets 28 and 38 to frame member 12, so that the operator may control the motion of the tool. The relatively wide, non-collinear placement of the grommets allows up and down motion to be imparted to frame member 12, as well as torque about the longitudinal axis of frame member 12. This allows the operator to control the tool without a subjectively spongy or sloppy control feel.

It can be seen that the form of the resilient fittings may change while still maintaining a desired level of controllability, as long as sufficient spacing between the points of interaction between upper handle assembly 18 and the tool. For example, a single resilient bushing extending the length of crossbar 16 may be used in place of grommets 28, shaped so that legs 20 do not directly contact crossbar 16. A single bolt may pass through legs 20 and the resilient bushing to retain upper handle assembly 18. In this exemplary embodiment, merely two resilient fittings are employed, while retaining sufficient spacing to control the tool.

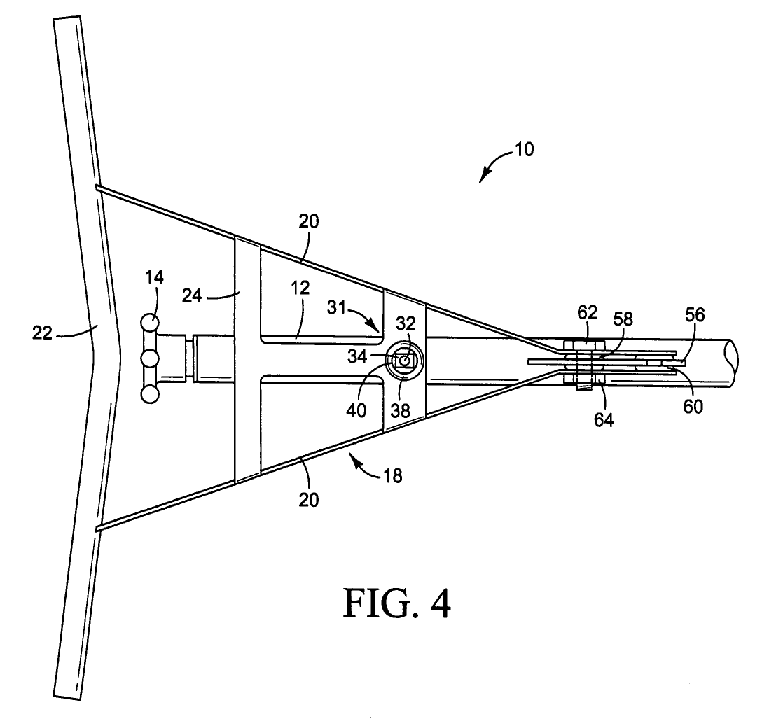

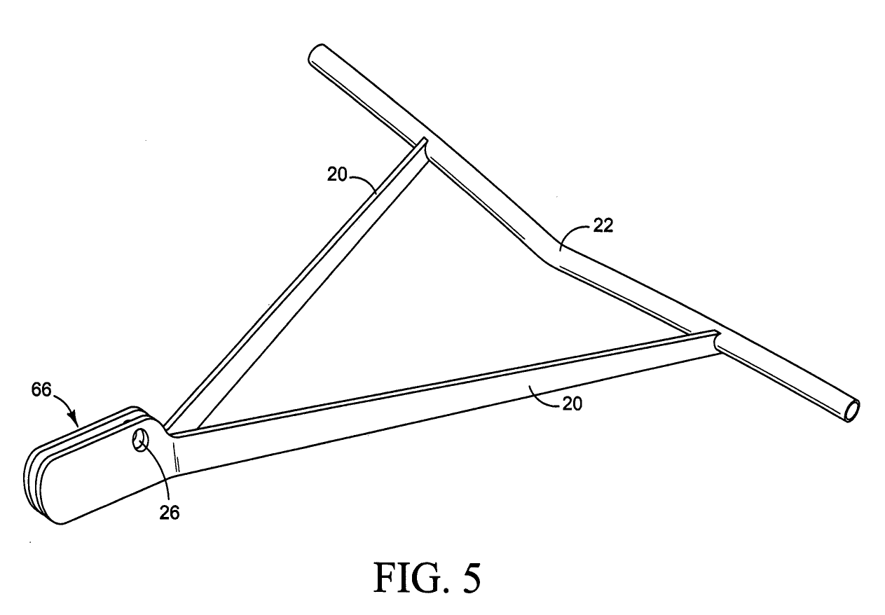

In another exemplary embodiment, shown in FIGS. 4 and 5, regions of contact between the handle assembly and the frame are arranged generally collinearly. Referring to FIG. 4, a flange 56 is attached to frame member 12 via welding, screws, rivets, or other secure attachment method. Resilient grommets 58 and 60 pass through holes in flange 56, so that resilient material is fitted between legs 20 and flange 56, creating two contact regions. Bolt 62 passes through holes 26 in legs 20, through grommet 58 and flange 56 to act as a hinge for upper handle assembly 18. Threaded nut 64 secures bolt 62 to the assembly. As in some embodiments described above, a third region of contact is provided by grommet 38, which is installed in subframe 24 and connected to height control assembly 31.

In operation, upper handle assembly 18 rotates about grommet 58, and the angle between upper handle assembly 18 and frame member 12 is controlled by height control assembly 31. Note that knob 36 is not shown for clarity. Grommets 38, 58, and 60 isolate upper handle assembly 18 from vibrations transmitted by frame member 12.

Pitch forces applied by the operator to handlebar 22 are primarily transmitted to frame member 12 by grommets 38 and 58. Roll force, torque applied about the long axis of frame member 12, is transmitted primarily by grommets 58 and 60. To improve the transmission of torque, and thus controllability, grommet 60 and the corresponding region 66 near the ends of legs 20 may be enlarged to increase the area of contact and the resulting moment arm, as shown in FIG. 5.

A skilled artisan will appreciate that the configuration of the embodiment shown in FIGS. 4 and 5 may be changed without significantly affecting the operation of the handle. For example, the positions of grommets 58 and 60 may be exchanged, so that the hinge axis is spaced farther away from handle 22. Grommet 58 may be enlarged, and the size of both grommets 58 and 60 adjusted to achieve specific torque and vibration dampening characteristics. Grommets 58 and 60 may be made of neoprene or other resilient material, and may be replaced with resilient washers, such as rubber washers or fiber washers. Bolt 62 may be replaced by a hinge pin and retained by a cotter pin.

From the foregoing, it will be appreciated that the handle for power tools provided by the embodiments described above, provide the key benefits of adjustable height and vibration dampening while retaining stability and control. It is also apparent that the embodiments of the invention described above are relatively inexpensive, having relatively few parts and requiring little precision machining. The embodiments are easily disassembled and reassembled for cleaning and maintenance.

The exemplary embodiments shown in the figures and described above illustrate but do not limit the invention. It should be understood that there is no intention to limit the invention to the specific form disclosed; rather, the invention is to cover all mobifications, alternative constructions, and equivalents falling within the spirit and scope of the invention as defined in the claims. For example, while embodiments of the present invention were developed for concrete power trowels, the invention is not limited to use with concrete power trowels and may be used with other power tools. While the invention is not limited to use with concrete power trowels, it is expected that various embodiments of the invention will be particularly useful in such devices. Hence, the foregoing description should not be construed to limit the scope of the invention, which is defined in the following claims.

What is claimed is:

1. A handle for a power tool, comprising:
a frame member;
a handle assembly, wherein the handle assembly is connected to the frame member by a first contact region, a second contact region and a third contact region; and
resilient material placed between the frame member and the handle assembly at the first contact region, a second contact region and a third contact region;
whereby the resilient material dampens vibrations generated by the power tool.

2. The handle of claim 1, wherein the first, second and third contact regions are collinear.

3. The handle of claim 1, wherein the first, second and third contact regions are not collinear.

4. The handle of claim 3, wherein first contact region is spaced at least six inches from the second contact region.

5. The handle of claim 1, further comprising a height control assembly that interconnects the handle assembly and the frame member through the third contact region.

6. The handle of claim 5, wherein the handle assembly rotates about an axis defined by the first and second contact regions, and the height control assembly adjusts the distance between the frame member and the third contact region.

7. The handle of claim 5, wherein the height control assembly further comprises:
a threaded rod; and
a threaded fastener, wherein the threaded fastener screws onto the threaded rod to control the distance between the frame member and the handle assembly at the third contact region.

8. The handle of claim 1, wherein the resilient material comprises a grommet.

9. The handle of claim 1, wherein the resilient material comprises neoprene.

10. A handle for a floor-standing power tool, comprising:
an elongated member having a first end attached to the power tool, the elongated member extending upward to a second end; and
a handle assembly, wherein the handle assembly is connected to the elongated member near the second end by a plurality of flexible fittings, and wherein the flexible fittings conduct roll, pitch and yaw forces sufficient to control the power tool;
whereby the flexible fittings dampen vibrations generated by the power tool.

11. The handle of claim 10, wherein the plurality of flexible fittings comprises two flexible fittings.

12. The handle of claim 10, wherein the plurality of flexible fittings are approximately collinear.

13. The handle of claim 10, wherein the plurality of flexible fittings are not collinear.

14. The handle of claim 10, wherein the plurality of flexible fittings comprises a grommet.

15. The handle of claim 10, wherein the plurality of flexible fittings comprises neoprene.

16. The handle of claim 10, further comprising a height control assembly that interconnects the handle assembly and the frame member via at least one of the plurality of flexible fittings, wherein the height control assembly adjusts the distance between the frame member and the handle assembly.

17. The handle of claim 16, wherein the height control assembly further comprises:
a threaded rod; and
a threaded fastener, wherein the threaded fastener screws onto the threaded rod to control the distance between the frame member and the handle assembly.

18. A concrete power trowel, comprising:
an engine;
a blade driven by the engine;
a frame member extending upward from the engine; and
a handle assembly, wherein the handle assembly is connected to the frame member by a first resilient fitting, a second resilient fitting and a third resilient fitting;
whereby the first, second and third resilient fittings dampen vibrations generated by the concrete power trowel.

19. The concrete power trowel of claim 18, wherein the first, second and third resilient fittings are approximately collinear.

20. The concrete power trowel of claim 18, wherein the first, second and third resilient fittings are not collinear.

21. The concrete power trowel of claim 18, further comprising a height control assembly that interconnects the handle assembly and the frame member through the third resilient fitting, wherein the height control assembly adjusts the distance between the frame member and the third resilient fitting.

22. The concrete power trowel of claim 21, wherein the height control assembly further comprises:
a threaded rod; and
a threaded fastener connected to the third resilient fitting, wherein the threaded fastener screws onto the threaded rod to control the distance between the frame member and the resilient fitting.

23. The concrete power trowel of claim 18, wherein the first resilient fitting comprises a grommet.

24. The concrete power trowel of claim 18, wherein the first, second and third resilient fittings comprise neoprene.

25. A handle for a power tool, comprising:
an elongated member;
a threaded member attached to the elongated member;
a handle assembly comprising a handlebar, a first leg, a second leg, and a subframe connecting the first leg and the second leg;
a first resilient grommet passing through the first leg;
a second resilient grommet passing through the second leg, wherein the handle assembly is capable of rotating about the first and second resilient grommets;
a third resilient grommet passing through the subframe not collinear with the first and second resilient grommets;
a first bolt passing through the first grommet and threaded into the threaded member;
a second bolt passing through the second grommet and threaded into the threaded member; and
a height control assembly flexibly connected to the elongated member and connected to the third resilient grommet, wherein the height control assembly adjusts the distance between the frame member and the third resilient grommet.

26. The concrete power trowel of claim 25, wherein the height control assembly further comprises:
a threaded rod; and
a threaded fastener connected to the third resilient grommet, wherein the threaded fastener screws onto the threaded rod to control the distance between the frame member and the subframe.

27. A handle for a power tool, comprising:
an elongated member;
a flange attached to the elongated member and defining a first hole and a second hole;
a first resilient grommet passing through the first hole;
a second resilient grommet passing through the second hole;
a handle assembly comprising a handlebar, a first leg, a second leg, and a subframe connecting the first leg and the second leg, the subframe defining a third hole;
a third resilient grommet passing through the third hole;
a bolt passing through the first resilient grommet, the first leg, and the second leg;
wherein the handle assembly is capable of rotating about the bolt; and
a height control assembly rotatably connected to the elongated member and connected to the third grommet, wherein the height control assembly adjusts the distance between the frame member and the third resilient grommet;
wherein the first and second resilient grommets prevent the first leg, the second leg, and the bolt from the contacting the flange.

28. The concrete power trowel of claim 27, wherein the height control assembly further comprises:
a threaded rod; and
a threaded fastener connected to the third grommet; wherein the threaded fastener screws onto the threaded rod to control the distance between the elongated member and the subframe.

29. The concrete power trowel of claim 27, wherein the first, second and third grommets are approximately collinear.

30. A handle for a power tool, comprising:
a frame member;
handle means for controlling the power tool;
resilient means for interconnecting the handle means with the frame member; and
means for controlling the height of the handle means.

31. A handle for a floor-standing power tool, comprising:
an elongated member having a first end attached to the power tool, the elongated member extending upward to a second end, the first end and second end defining an axis; and
a handle assembly, wherein the handle assembly is connected to the elongated member by a first flexible contact region and a second flexible contact region, the first and second flexible contact regions disposed laterally on each side of a plane defined by the axis, the lateral displacement the first and second contact regions from the plane sufficient to control the power tool around the axis.

32. The handle of claim 31, wherein the first flexible contact region comprises a grommet.

33. The handle of claim 31, wherein the first and second flexible contact regions together comprise a single grommet bifurcated by the plane.

34. The handle of claim 31, further comprising a height control assembly that interconnects the handle assembly and the elongated member through a third flexible contact region, wherein the height control assembly adjusts the distance between the elongated member and the third flexible contact region.

35. The concrete power trowel of claim 34, wherein the height control assembly further comprises:
a threaded rod; and
a threaded fastener connected to the third flexible contact region, wherein the threaded fastener screws onto the threaded rod to control the distance between the elongated member and the third flexible contact region.
